(19) United States
(12) Patent Application Publication
(10) Pub. No.: US 2007/0263980 A1
(43) Pub. Date: Nov. 15, 2007

(54) METHOD OF TRANSITIONING FROM TIME SHIFTED MULTIMEDIA PLAYBACK TO LIVE MULTIMEDIA PLAYBACK AND MULTIMEDIA PLAYBACK DEVICE THEREOF

(76) Inventors: Jaan-Huei Chen, Taipei Hsien (TW); Kan-Li Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/382,275

(22) Filed: May 9, 2006

(51) Int. Cl. H04N 5/91

(52) U.S. Cl. 386/68

(57) ABSTRACT

A method of transitioning from playback of time shifted multimedia data in a time shifted playback mode to playback of live multimedia data in a live playback mode includes buffering data corresponding to the live multimedia data in a buffer; storing data corresponding to the live multimedia data to a storage medium; calculating a next playback data block according to the time shifted playback mode; retrieving data corresponding to the next playback data block from the storage medium if the data corresponding to the next playback data block is available from the storage medium; and retrieving the data corresponding to the next playback data block from the buffer if the data corresponding to the next playback data block is not available from the storage medium but is available from the buffer.

### BACKGROUND

The invention relates to multimedia devices, and more particularly, to transitioning from playback of time shifted multimedia data in a time shifted playback mode to playback of live multimedia data in a live playback mode.

Various devices have been developed to enable consumers to record video and/or audio programs for later presentation. Such devices include tape recorders, video cassette recorders, recordable compact discs, and most recently, recordable digital video discs (DVD). Hard drives of personal computers and magneto optical discs have also been used.

A number of new features for rewritable storage media, for example magnetic based storage media, include pause, fast-forward, catch-up, and instant replay. These features require apparently simultaneous reading of information from the storage media and also writing of information to the storage media. For example, when a user is currently recording a live television show, the user can pause the display of the live television show but the recording operation still continues in the background. Later, upon resuming playback, the user could then use the fast-forward function to catch back up to the live television show. These features require that operation of the write buffer (also referred to as the record buffer) and the read buffer (also referred to as the track or play buffer) be optimized to avoid write buffer overflow read buffer underflow. Write buffer overflow results in a loss of program material after encoding and before writing onto the disk. Read buffer underflow results in an interruption of the program material as it is being played back. Catch-up modes, play-skip modes and smooth-catch-up modes or combinations of them all require such buffer optimization.

Pause, instant replay, catch-up, and all other trick modes are good features for multimedia playback devices. Here, pause is used to pause a broadcast TV program. Instant replay allows people to watch the recording instantly. Catch-up happens when the playback speed is faster than the recording speed of live content input. And other trick modes include fast reverse, slow reverse, fast forward, slow forward, skip, and jump, among other functions.

One difficultly that is encounter in these trick modes is allowing for smooth transition from time-shifted playback (such as fast-forward) back to the live playback. In the time-shift mode, a TV program will be stored in the time-shift buffer of a storage medium (e.g., a hard disk drive HDD) temporarily. The TV program is then later played back from the HDD. While operating in this time-shift mode, a user can perform trick playback modes such as a fast forward mode to skip some program components such as commercials etc. When operating in the fast forward mode, the time-shift playback point will eventually catch up to the incoming live video. At this point it is desirable to switch playback to be directly from the live playback so that there is no unnecessary delay encountered when watching the TV program.

FIG. 1 shows the data path of a first typical multimedia device 100 according to the related art. For example, the multimedia device 100 could be utilized to record and playback video and includes an input port 102 (such as an analog to digital converter for video input), an encoder 104, a write buffer 106, a hard drive (HDD) 108, a read buffer 110, a decoder 112, an output switch 114, an output buffer 116, and an output port 118. As indicated in FIG. 1, when the system applies to a video application, the devices within the top half of FIG. 1 operate on frames in the incoming bit-stream received at the input port 102 and the bottom half of FIG. 1 operate on groups of pictures (GOP).

FIG. 2 shows the data path of a second typical multimedia device 200 according to the related art. When the system applies to a video application, the data path of the second typical multimedia device 200 allows a picture in picture (PIP) function to be performed. To support the PIP function (already specified for video applications), the output switch needs to have a mixer function. When time-shifted content catches up live content, the primary display will be switched to live content and the secondary display will be turned off automatically. As shown in FIG. 2, the multimedia device 200 includes an input port 202, an input buffer 203, an encoder 204, a write buffer 206, a hard drive (HDD) 208, a read buffer 216, a decoder 214, an output switch 210, and an output port 220. As indicated in FIG. 2, the devices within the top half of FIG. 2 operate on frames in the incoming bit-stream received at the input port 202 and the bottom half of FIG. 2 operate on groups of pictures (GOP).

As an example, FIG. 3 shows buffer usage during a time shift operation such as when fast-forwarding through video data stored on the HDD 108, 208 of FIG. 1 and FIG. 2. Initially, the output switch 114, 210 is positioned to pass frames of video output by the decoder 112 or the output buffer 212 to the output port 118, 220. As shown in FIG. 3, a current encoded group of pictures is stored in the write buffer 106, 206. At the same time, a previously stored (and therefore complete) group of pictures is written into the HDD 108, 208. On the playback side, a current group of pictures is read from the HDD 108, 208 and is stored in the read buffer 110, 216. Finally, a current decoding group of pictures is passed from the read buffer 110, 216 to the decoder 112, 214.

FIG. 4 shows buffer usage at the point in time when the time shift video data read position catches up to the live video data received at the input port 102, 202 of FIG. 1 and FIG. 2. As shown in FIG. 4, group of pictures 408 has already been displayed and according to the time shift playback mode the next frame to be displayed is located within group of pictures 406. However, group of pictures 406 has not yet been completely read from the HDD 108, 208. Likewise, group of pictures 404 is also not available because part of this group has already been written to the HDD 108, 208. In this way, the next group of pictures that can be displayed is 402. However, because the required frames within groups 404 and 406 were skipped, a user will notice a non-smooth transition from the time shifted video data to the live video data.

FIG. 5 shows a first method 500 of transitioning from fast-forwarding playback to non-fast-forwarding playback of time shifted multimedia data in a time shifted playback mode according to the related art. As shown in FIG. 5, after entering the fast forward mode, the related art method 500 includes the following steps:

Step 502: Determine a next playback data block according to the fast forward (time shift) mode.

Step 504: Is the next data block available from the HDD? If yes, proceed to step 506; otherwise, proceed to step 510.

Step 506: Retrieve the next data block from the HDD and send the next data block to the decoder.

Step 508: Is the fast forward mode still required by the user? If yes, return to step 502; otherwise, exit the fast forward mode.

Step 510: Wait until the next data block is available from the HDD and then pass it to the decoder. Once the next data block has been passed to the decoder, exit the fast forward mode.

FIG. 6 shows a second method 600 of transitioning from playback of time shifted multimedia data in a time shifted playback mode to playback of live multimedia data in a live playback mode according to the related art. As shown in FIG. 6, after entering the fast forward mode, the related art method 500 includes the following steps:

Step 602: Determine a next playback data block according to the fast forward (time shift) mode.

Step 604: Is the next data block available from the HDD? If yes, proceed to step 606; otherwise, proceed to step 608.

Step 606: Retrieve the next data block from the HDD and send the next data block to the video decoder for display.

Step 610: Is the fast forward mode still required by the user? If yes, return to step 602; otherwise, exit the fast forward mode.

Step 608: Simply exit the fast forward mode and begin to display the live video data since the display has now caught up to the live video data.

However, both the methods 500, 600 of FIG. 5 and FIG. 6 both have a non-smooth transition from the fast forward mode to the live video mode. That is, according to the time shift mode, it might be required to display some data blocks from group of pictures that are currently being written to the hard drive or are currently being read from the hard drive. Instead, both the methods 500, 600 of FIG. 5 and FIG. 6 will jump to the live video data which will appear to the user to be too far in advance. In this way, the user will notice a non-smooth transition to the live video data.

### SUMMARY

One objective of the claimed invention is therefore to provide a method of transitioning from playback of time shifted multimedia data in a time shifted playback mode to playback of live multimedia data in a live playback mode, to solve the above-mentioned problem.

According to an exemplary embodiment of the claimed invention, a method is disclosed for transitioning from playback of time shifted multimedia data in a time shifted playback mode to playback of live multimedia data in a live playback mode. The method comprises buffering data corresponding to the live multimedia data in a buffer; storing data corresponding to the live multimedia data to a storage medium; calculating a next playback data block according to the time shifted playback mode; retrieving data corresponding to the next playback data block from the storage medium if the data corresponding to the next playback data block is available from the storage medium; and retrieving the data corresponding to the next playback data block from the buffer if the data corresponding to the next playback data block is not available from the storage medium but is available from the buffer.

According to another exemplary embodiment of the claimed invention, a multimedia playback device is disclosed comprising a buffer being coupled to live multimedia data for buffering data corresponding to the live multimedia data; a storage medium being coupled to the buffer for storing data corresponding to the live multimedia data; a next playback block calculator for calculating a next playback data block according to a time shifted playback mode; and a switching unit being coupled to the next playback block calculator for retrieving data corresponding to the next playback data block from the storage medium if the data corresponding to the next playback data block is available from the storage medium, and for retrieving the data corresponding to the next playback data block from the buffer if the data corresponding to the next playback data block is not available from the storage medium but is available from the buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows the data path of a first typical multimedia device according to the related art.

FIG. 2 shows the data path of a second typical multimedia device according to the related art.

FIG. 3 shows buffer usage during a time shift operation such as when fast-forwarding through video data stored on the HDD of FIG. 1 and FIG. 2.

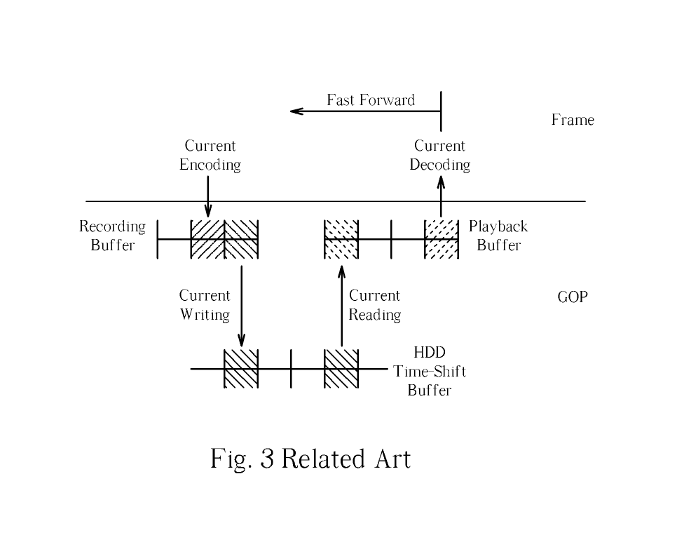

FIG. 4 shows buffer usage at the point in time when the time shift video data catches up to the live video data received at the video input of FIG. 1 and FIG. 2.

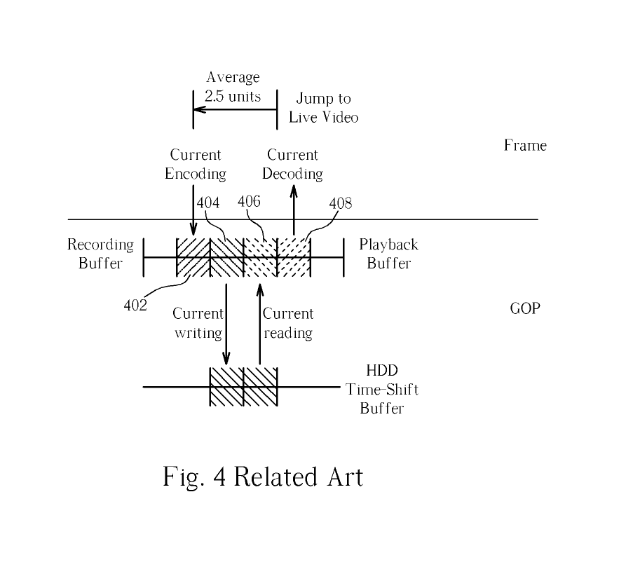

FIG. 5 shows a first method of transitioning from fast-forwarding to non-fast-forwarding playback of time shifted multimedia data in a time shifted playback mode according to the related art.

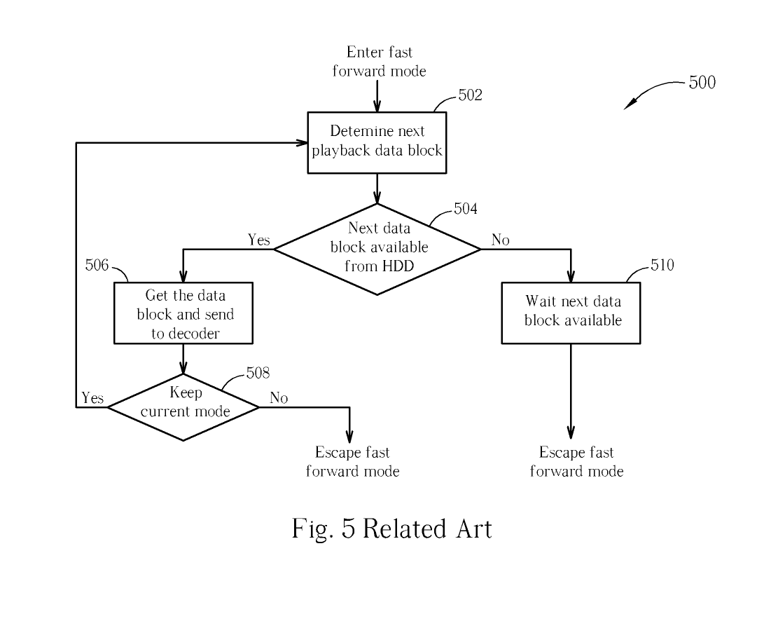

FIG. 6 shows a second method of transitioning from playback of time shifted multimedia data in a time shifted playback mode to playback of live multimedia data in a live playback mode according to the related art.

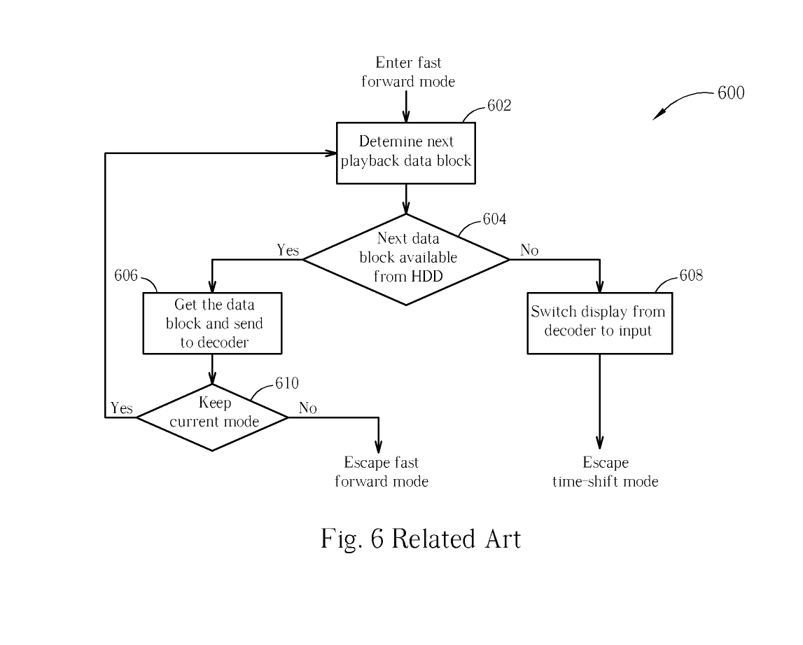

FIG. 7 shows a multimedia playback device according to a first exemplary embodiment.

FIG. 8 shows the data path of a second multimedia device according to another exemplary embodiment.

FIG. 9 shows the data path of a third multimedia device according to another exemplary embodiment.

FIG. 10 shows buffer usage during a time shift operation such as when fast-forwarding through multimedia data stored on the HDD in the above descriptions of FIG. 8 and FIG. 9.

FIG. 11 shows a frame buffer usage diagram to further explain what is meant by all data blocks right up to the live video data can be utilized in the time shift mode in the above descriptions of FIG. 8 and FIG. 9.

FIG. 12 shows a first method of transitioning from fast-forwarding playback of time shifted multimedia data in a time shifted playback mode to non-fast-forwarding playback of time shifted multimedia data in a time shifted playback mode according to an exemplary embodiment.

FIG. 13 shows a second method of transitioning from playback of time shifted multimedia data in a time shifted playback mode to playback of live multimedia data in a live playback mode according to an exemplary embodiment.

FIG. 14 shows a third method of transitioning from playback of time shifted multimedia data in a time shifted playback mode to playback of live multimedia data in a live playback mode according to an exemplary embodiment.

FIG. 15 shows the data path of another multimedia device according to another exemplary embodiment.

FIG. 16 shows a generalized method of transitioning from playback of time shifted multimedia data in a time shifted playback mode to playback of live multimedia data in a live playback mode according to an exemplary embodiment.

FIG. 17 shows a fade in effect for a video data combined with audio data application according to an exemplary embodiment.

FIG. 18 shows a fade in effect for an audio only data application according to an exemplary embodiment.

### DETAILED DESCRIPTION

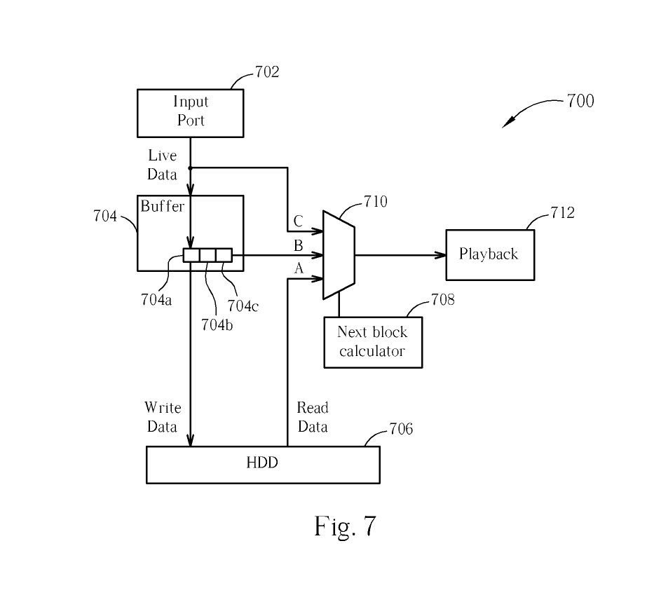

FIG. 7 shows a multimedia playback device 700 according to a first exemplary embodiment. As shown in FIG. 7, the multimedia playback device 700 includes an input port 702, a buffer 704, a hard disk drive (HDD) 706, a switching unit 710, a next block calculator 708, and a playback device 712. As will be mentioned, the multimedia playback device 700 could be utilized for recording and playback of audio data, video data, or a combination of both. As will be readily apparent to a person skilled in the art after having read the following disclosure, other types of multimedia data could also be utilized in accordance with these embodiments.

To allow for a smooth transition from time shifted video playback to live video playback, the present invention includes the buffer 704, which is for buffering data corresponding to the live multimedia data. A first set of data 704a is currently being written to the HDD. However, after being written to the HDD 706, this set of data is now available as data set 704b. Likewise, to make up for the block of data that is currently being read from the HDD 706, buffer 704 also includes a previous set of data 704c. In this way, if the next block calculator 708 determines that the next data block is located on the HDD 706, the switching unit 710 passes the next block from the HDD 706 to the playback device 712 (this is shown as signal path A in FIG. 7). Alternatively, if the next block calculator 708 determines that the next data block is not yet available from the HDD 706, for example because it is currently being read or written to the HDD, the switching unit 710 passes the next block from the buffer 704 to the playback device 712 (this is shown as signal path B in FIG. 7). Finally, if the next block calculator 708 determines that the next data block is not yet available from the buffer 704, for example because it is currently being received as live multimedia data to the buffer 704 or else will be received sometime in the future, the switching unit 710 passes the next block directly from the input port 702 to the playback device 712 (this is shown as signal path C in FIG. 7). Then the multimedia playback device 700 exits the time shift mode because the fast forward function has now caught up to the live video data and it is no longer possible to fast forward. Further examples and more detailed description of particular embodiments and their operations are shown in the following figures.

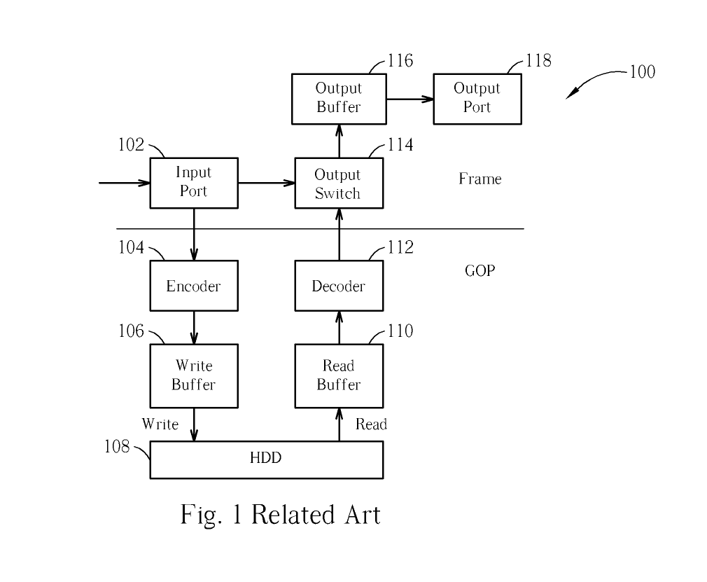

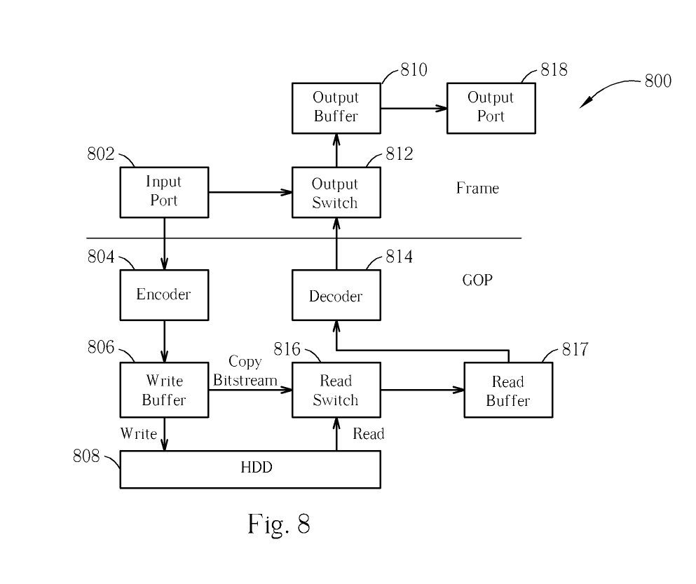

FIG. 8 shows the data path of a second multimedia device 800 according to another exemplary embodiment. As shown in FIG. 8, the multimedia device 800 includes an input port (such as an analog to digital converter) 802, an encoder (compress input data into bit-stream) 804, a write buffer 806, a hard drive (HDD) 808, a read switch 816, a read buffer 817, a decoder 814, an output switch 812, an output buffer 810, and an output port 818. When applies the system to video application, as indicated in FIG. 8, the devices within the top half of FIG. 8 operate on frames in the incoming data received at the input port 802, while the bottom half of FIG. 8 operate on groups of pictures (GOP). Note that unlike in FIG. 1, in this embodiment the bit-stream is also directly copied from the write buffer 806 to the read buffer 817 via the read switch 816. In this way, the group of pictures that is currently being written to the HDD 808 and the group of pictures that is currently being read from the HDD 808 will both be available from the read buffer 817. Therefore, when time shift playback point catches up to the live input video, all data blocks right up to the live video data can be utilized in the time shift mode and the transition to the live video data will be smooth.

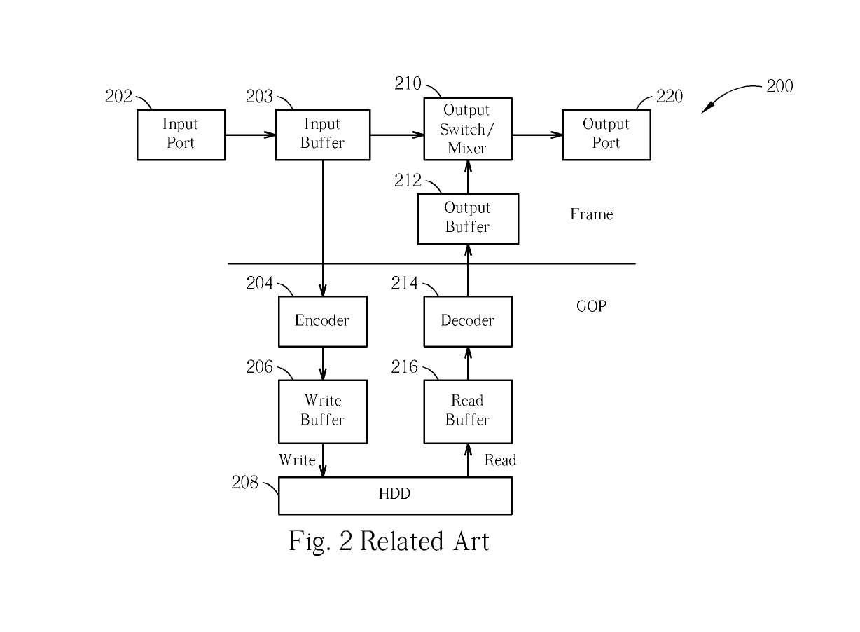

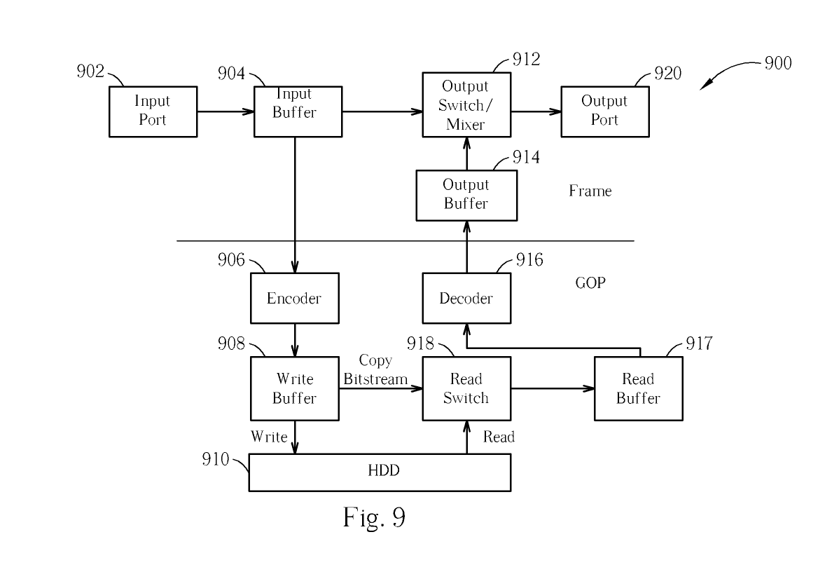

FIG. 9 shows the data path of a third multimedia device 900 according to another exemplary embodiment. The data path of the third multimedia device 900 allows a picture in picture (PIP) function to be performed when the system is applied to a video application. As shown in FIG. 9, the multimedia device 900 includes an input port 902, an input buffer 904, an encoder 906, a write buffer 908, a hard drive (HDD) 910, a read switch 918, a read buffer 917, a decoder 916, an output buffer 914, an output switch 912, and an output port 920. As indicated in FIG. 9, the devices within the top half of FIG. 9 operate on frames in the incoming data received at the input port 202 while the bottom half of FIG. 9 operate on groups of pictures (GOP). Note that unlike in FIG. 2, in this embodiment the bit-stream is also directly copied from the write buffer 908 to the read buffer 917 via the read switch 918. In this way, the group of pictures that is currently being written to the HDD 910 and the group of pictures that is currently being read from the HDD 910 will both be available from the read buffer 917. Therefore, when the time shift playback point catches up to the live input video, all data blocks right up to the live video data can be utilized in the time shift mode and the transition to the live multimedia data will be smooth.

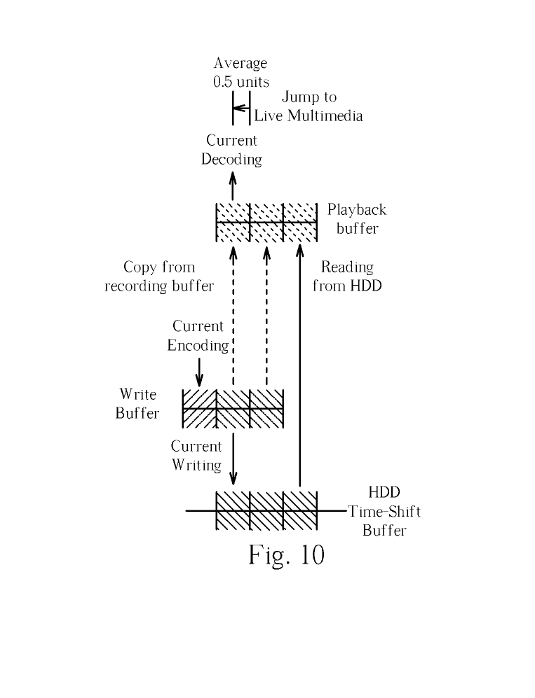

FIG. 10 shows buffer usage during a time shift operation such as when fast-forwarding through multimedia data stored on the HDD 808, 908 of FIG. 8 and FIG. 9. As shown in FIG. 10, a current encoded data block is stored in the write buffer 806, 908. At the same time, a previously stored (and therefore complete) data block is written into the HDD 808, 910. Additionally, if required, the data block that is currently being written into the HDD 808, 910 is also passed to the read buffer 817, 917 via the read switch 816, 918. On the playback side, a data block is read from the HDD 808, 910 and is stored in the read buffer 817, 917. When time shift playback point catches up live input data, the data in the write buffer 806, 908 have to been copied into read buffer 817, 917. In this way, the correct next data block according to the time shift mode can be passed from the read buffer 817, 917 to the video decoder 814, 916.

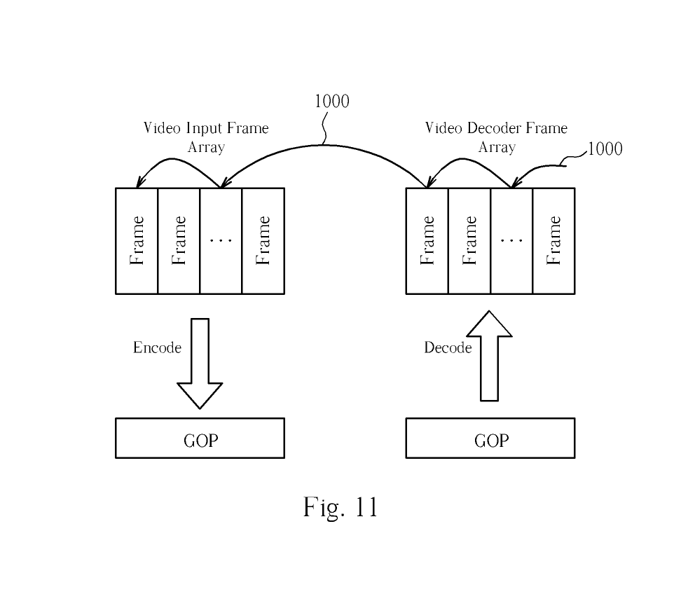

Furthermore, the input buffer data also could be used. When the system is applied to a video application, FIG. 11 shows a frame buffer usage diagram to further explain what is meant by all data blocks right up to the live video data can be utilized in the time shift mode in the above descriptions of FIG. 9. As shown in FIG. 11, the video input frame array contains frames corresponding to groups of pictures that have already been encoded and stored on the HDD and video decoder frame array corresponding to groups of pictures that are currently being read from the HDD. When the next block calculator 708 determines that next data block is not located on the HDD and write buffer, the next display frame for the fast-forwarding mode may already be available in the video input frame array. This is shown by line 1000 in FIG. 11. If the next required data block is not located in the video decoder and video input frame array, then this means that the fast forward operation has now caught up to the live video data. It should escape time shift mode and next input frame (without frame skipping) will be sent to output port directly.

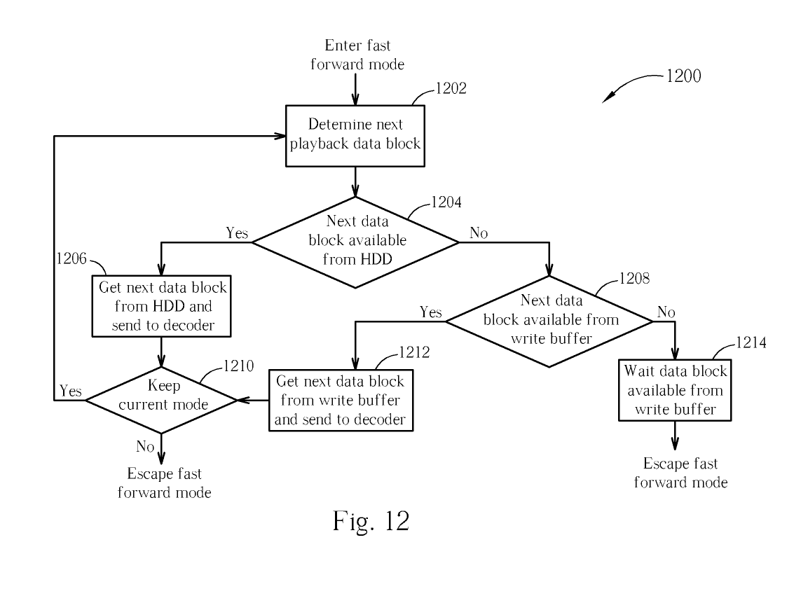

FIG. 12 shows a first method 1200 of transitioning from fast-forwarding playback of time shifted multimedia data in a time shifted playback mode to non-fast-forwarding playback of time shifted multimedia data in a time shifted playback mode according to an exemplary embodiment. Provided that substantially the same result is achieved, the steps of the flowchart shown in FIG. 12 need not be in the exact order shown and need not be contiguous, that is, other steps can be intermediate. As shown in FIG. 12, after entering the fast forward mode, method 1200 includes the following steps:

Step 1202: Determine a next playback data block according to the fast forward (time shift) mode.

Step 1204: Is the next data block available from the HDD? If yes, proceed to step 1206; otherwise, proceed to step 1208.

Step 1206: Retrieve the next data block from the HDD and send the next data block to the multimedia decoder for display.

Step 1208: Is the next data block available from the write buffer? If yes, proceed to step 1212; otherwise, proceed to step 1214.

Step 1210: Is the fast forward mode still required by the user? If yes, return to step 1202; otherwise, exit the fast forward mode.

Step 1212: Retrieve the next data block from the write buffer and send the next data block to the multimedia decoder for display.

Step 1214: Wait until the next data block is available from the write buffer and then pass it to the multimedia decoder for playback. Once the next data block has been passed to the multimedia decoder, exit the fast forward mode since the playback has now caught up to the live multimedia data.

In another embodiment, step 1214 can be modified to instead repeat a last played data block while waiting for the data corresponding to the next playback data block to become available from the write buffer if the next playback data block is not available from the storage medium and is not yet available from the write buffer. Once the next data block has been passed to the multimedia decoder, exit the fast forward mode since the playback has now caught up to the live multimedia data.

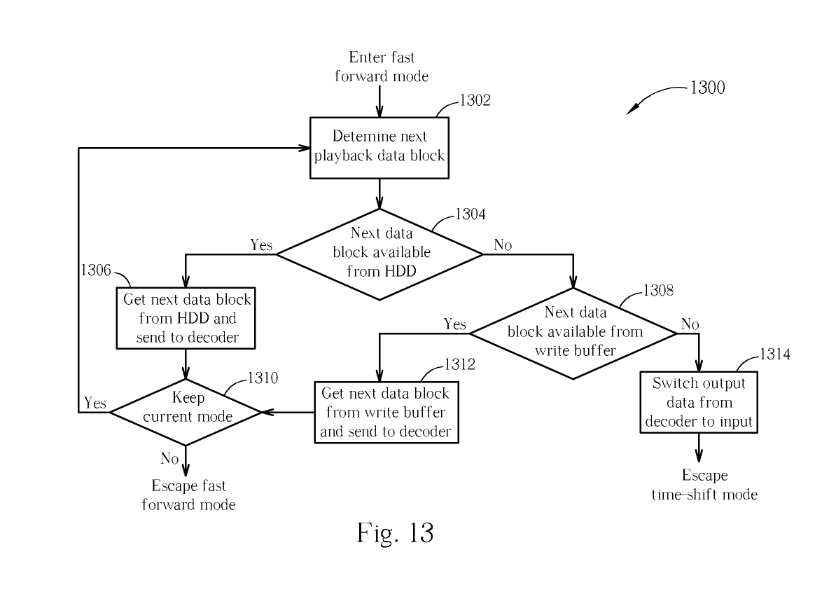

FIG. 13 shows a second method 1300 of transitioning from playback of time shifted multimedia data in a time shifted playback mode to playback of live multimedia data in a live playback mode according to an exemplary embodiment. Provided that substantially the same result is achieved, the steps of the flowchart shown in FIG. 13 need not be in the exact order shown and need not be contiguous, that is, other steps can be intermediate. As shown in FIG. 13, after entering the fast forward mode, method 1300 includes the following steps:

Step 1302: Determine a next playback data block according to the fast forward (time shift) mode.

Step 1304: Is the next data block available from the HDD? If yes, proceed to step 1306; otherwise, proceed to step 1308.

Step 1306: Retrieve the next data block from the HDD and send the next data block to the video decoder for display.

Step 1308: Is the next data block available from the write buffer? If yes, proceed to step 1312; otherwise, proceed to step 1314.

Step 1310: Is the fast forward mode still required by the user? If yes, return to step 1302; otherwise, exit the fast forward mode.

Step 1312: Retrieve the next data block from the write buffer and send the next data block to the multimedia decoder for playback.

Step 1314: Exit the time shift mode and begin to output the live data since the output data range has now caught up to the live video data.

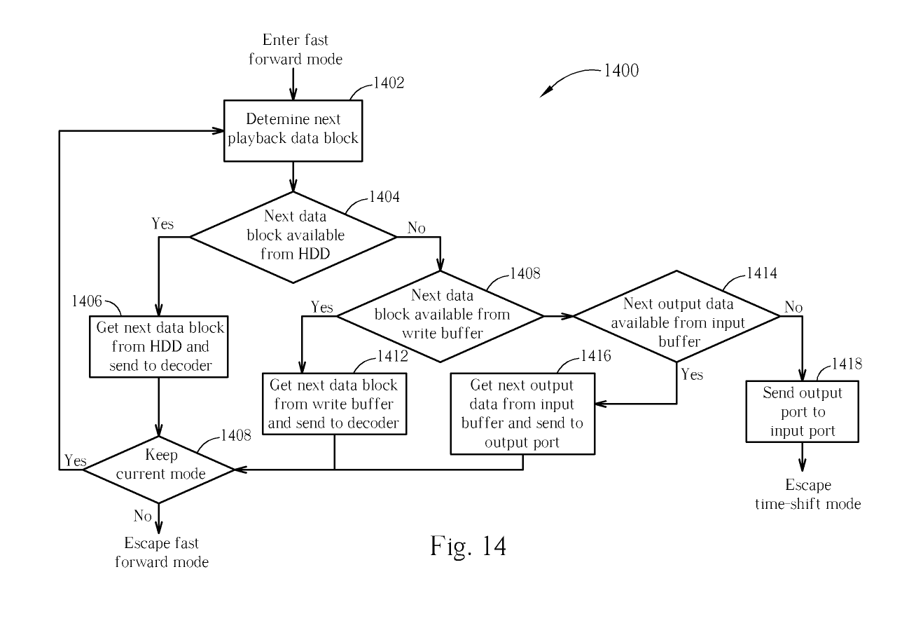

FIG. 14 shows a third method 14 00 of transitioning from playback of time shifted multimedia data in a time shifted playback mode to playback of live multimedia data in a live playback mode according to an exemplary embodiment. Provided that substantially the same result is achieved, the steps of the flowchart shown in FIG. 14 need not be in the exact order shown and need not be contiguous, that is, other steps can be intermediate. As shown in FIG. 14, after entering the fast forward mode, method 14 00 includes the following steps:

Step 1402: Determine a next playback data block according to the fast forward (time shift) mode.

Step 1404: Is the next data block available from the HDD? If yes, proced to step 1406; otherwise, proceed to step 1412.

Step 1406: Retrieve the next data block from the HDD and send the next data block to the video decoder for display.

Step 1408: Is the fast forward mode still required by the user? If yes, return to step 1402; otherwise, exit the fast forward mode.

Step 1410: Is the next data block available from the write buffer? If yes, proceed to step 1412; otherwise, proceed to step 1414.

Step 1412: Retrieve the next data block from the write buffer and send the next data block to the multimedia decoder for playback.

Step 1414: Is the next output data available from the input buffer? If yes, proceed to step 1416; otherwise, proceed to step 1418.

Step 1416: Retrieve the next output data from the input buffer and send the next output data to the output port for output.

Step 1418: Exit the fast forward mode and begin to display the live data since the output data range has now caught up to the live data.

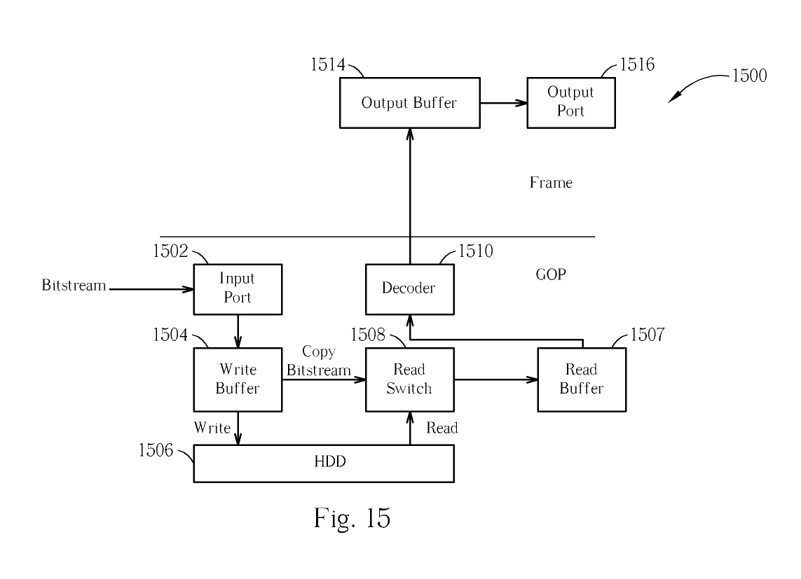

FIG. 15 shows the data path of another multimedia device 1500 according to another exemplary embodiment. As shown in FIG. 15, the multimedia device 15 00 could be utilized in a digital television (DTV) application. In this case, the incoming live multimedia data is already in a digital compressed bit-stream form and does not need to be further encoded. So an encoder is not required and the write buffer to HDD could be used as input buffer of the input port.

The multimedia device 1500 includes an input port 1502 such as a transport stream (TS) demultiplexer, a write buffer 1504, a hard drive (HDD) 1506, a read switch 1508, a read buffer 1507, a decoder 1510, a output buffer 1514, and an output port 1516. As indicated in FIG. 15, the received bit-stream is stored in the write buffer and then saved onto the HDD. Note that the bit-stream is also directly copied from the write buffer 1504 to the read buffer 1507 via the read switch 1508. Similar to the above described embodiments, in this way, the data block that is currently being written to the HDD 1506 and the data block that is currently being read from the HDD 1506 will both be available from the read buffer 1508. Therefore, when time shift playback point catches up live input data, the method 1200 also could be applied, and escape from fast-forwarding mode also implies escape from time-shift mode. All data blocks right up to the live video data can be utilized in the time shift mode and the transition to the live multimedia data will be smooth.

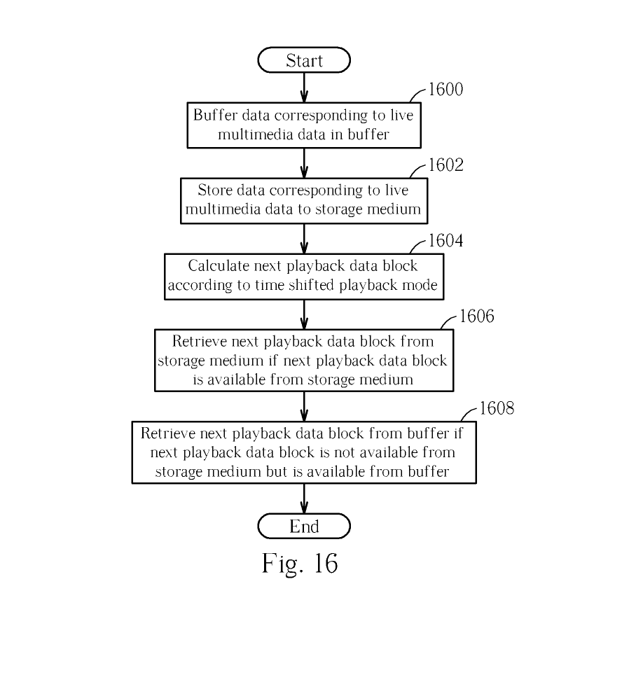

FIG. 16 shows a generalized method of transitioning from playback of time shifted multimedia data in a time shifted playback mode to playback of live multimedia data in a live playback mode according to an exemplary embodiment. Provided that substantially the same result is achieved, the steps of the flowchart shown in FIG. 16 need not be in the exact order shown and need not be contiguous, that is, other steps can be intermediate. As shown in FIG. 16, the method includes the following steps:

Step 1600: Buffer data corresponding to the live multimedia data in a buffer.

Step 1602: Store data corresponding to the live multimedia data to a storage medium.

Step 1604: Calculate a next playback data block according to the time shifted playback mode.

Step 1606: Retrieve the next playback data block from the storage medium if the next playback data block is available from the storage medium.

Step 1608: Retrieve the next playback data block from the buffer if the next playback data block is not available from the storage medium but is available from the buffer.

As previously mentioned, the multimedia data of the above-described embodiments could be video, audio, or other formats. Concerning video data combining with audio data, in the general fast forward case, the audio decoder is disabled and no sound output is performed in this case. Therefore, there is no audio switch problem when escaping time-shift mode and returning to live video mode. For audio only application, the fast forwarding may be implemented as playing one short period of audio data and then jumping a short distance to play another period of audio.

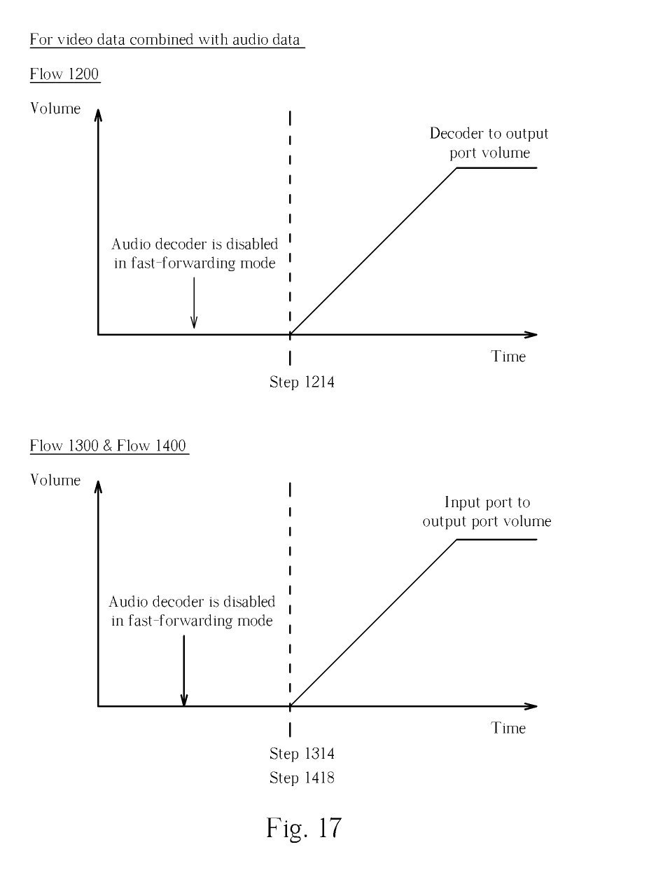

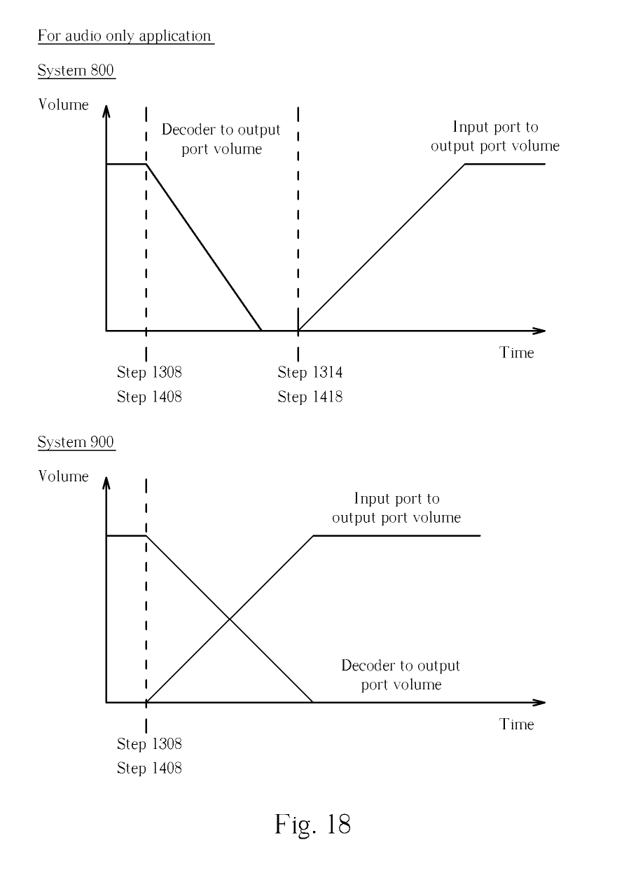

While switching output port data from decoder output to input port, to prevent undesired audio volume jump, the system does a fade-in effect on input audio and fade-out effect on decoder output audio, depending on system configuration. As shown in FIG. 17, for the video data combining with audio data case, when escaping fast-forwarding mode (step 1214) or time-shift mode (step 1314 and step 1418), a fade-in effect of the audio output data of the output port is performed. As shown in FIG. 18, for audio only application, the system could apply a fade-out effect on decoder output when transition starts (first time run to step 1308 and step 1408). Also note that there can be a soft-mute portion where there is no volume between the fade-out and fade-in, as is illustrated before the start of steps 1314 and 1418 in FIG. 18. For the fade-in effect, it depends on the system configuration. For system 800, the fade-in effect applies to step 1314 or step 1418, and could be implemented in input port 802 or output port 818. For system 900, the fade-in effect applies to input port 902, at, or after the step 1308 or step 1408.

The present invention provides a multimedia playback device allowing smooth transition from time shifted multimedia data to live multimedia data. A buffer is coupled to live multimedia data for buffering data corresponding to the live multimedia data. A storage medium is coupled to the buffer for storing data corresponding to the live multimedia data. A next playback block calculator calculates a next playback data block according to a time shifted playback mode. A switching unit is coupled to the next playback block calculator for retrieving the next playback data block from the storage medium if the next playback data block is available from the storage medium, and for retrieving the next playback data block from the buffer if the next playback data block is not available from the storage medium but is available from the buffer. In this way, the group of pictures that is currently being written to the storage medium and the group of pictures that is currently being read from the storage medium will both be available from the buffer. Therefore, all data blocks right up to the live video data can be utilized in the time shift mode and the transition to the live multimedia data will be smooth.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of transitioning from playback of time shifted multimedia data in a time shifted playback mode to playback of live multimedia data in a live playback mode, the method comprising:
buffering data corresponding to the live multimedia data in a buffer;
storing data corresponding to the live multimedia data to a storage medium;
calculating a next playback data block according to the time shifted playback mode;
retrieving data corresponding to the next playback data block from the storage medium if the data corresponding to the next playback data block is available from the storage medium; and
retrieving the data corresponding to the next playback data block from the buffer if the data corresponding to the next playback data block is not available from the storage medium but is available from the buffer.

2. The method of claim 1, further comprising sending the retrieved data to a decoder.

3. The method of claim 2, further comprising:
encoding the live multimedia data to thereby generate encoded multimedia data;
wherein buffering the data corresponding to the live multimedia data in the buffer further comprises buffering the encoded multimedia data in a write buffer; and storing the data corresponding to the live multimedia data to the storage medium further comprises storing the encoded multimedia data to the storage medium.

4. The method of claim 3, further comprising changing playback speed in the time shifted playback mode.

5. The method of claim 3, further comprising switching from playback of the time shifted multimedia data in the time shifted playback mode to playback of the live multimedia data in the live playback mode.

6. The method of claim 3, further comprising waiting for the data corresponding to the next playback data block to become available from the write buffer if the data corresponding to the next playback data block is not available from the storage medium.

7. The method of claim 6, further comprising repeating a last played data block while waiting for the data corresponding to the next playback data block to become available from the write buffer.

8. The method of claim 1, further comprising repeating a last played data block while waiting for the data corresponding to the next playback data block to become available from the buffer if the data corresponding to the next playback data block is not available from the storage medium and is not yet available from the buffer.

9. The method of claim 1, further comprising waiting for the data corresponding to the next playback data block to become available from the buffer if the data corresponding to the next playback data block is not available from the storage medium and is not yet available from the buffer.

10. The method of claim 9, further comprising resuming from the waiting for the data corresponding to the next playback data block to playback of the time shifted multimedia data in the time shifted playback mode after the next playback data block has become available in the buffer.

11. The method of claim 1, further comprising switching from playback of the time shifted multimedia data in the time shifted playback mode to direct playback of the live multimedia data in the live playback mode if the data corresponding to the next playback data block is neither available from the storage medium nor from the buffer.

12. The method of claim 1, further comprising directly buffering the live multimedia data in an input buffer.

13. The method of claim 12, further comprising retrieving the data corresponding to the next playback data block from the input buffer if the data corresponding to the next playback data block is not available from the storage medium but is available from the input buffer.

14. The method of claim 1, wherein the multimedia data comprises video data.

15. The method of claim 1, wherein the multimedia data comprises audio data.

16. A multimedia playback device comprising:
a buffer being coupled to live multimedia data for buffering data corresponding to the live multimedia data;
a storage medium being coupled to the buffer for storing data corresponding to the live multimedia data;
a next playback block calculator for calculating a next playback data block according to a time shifted playback mode; and
a switching unit being coupled to the next playback block calculator for retrieving data corresponding to the next playback data block from the storage medium if the data corresponding to the next playback data block is available from the storage medium, and for retrieving the data corresponding to the next playback data block from the buffer if the data corresponding to the next playback data block is not available from the storage medium but is available from the buffer.

17. The multimedia playback device of claim 16, further comprising a decoder being coupled to the switching unit, wherein the switching unit is further for sending the retrieved data to the decoder.

18. The multimedia playback device of claim 17, further comprising:
an encoder being coupled to the live multimedia data for encoding the live multimedia data to thereby generate encoded multimedia data;
wherein the buffer is a write buffer and the data corresponding to the live multimedia data being stored in the write buffer is the encoded multimedia data; and wherein the storage medium is further for storing the encoded multimedia data corresponding to the live multimedia data.

19. The multimedia playback device of claim 18, wherein the decoder is further for changing playback speed in the time shifted playback mode.

20. The multimedia playback device of claim 18, wherein the switching unit is further for switching from playback of the time shifted multimedia data in the time shifted playback mode to direct playback of the live multimedia data in the live playback mode.

21. The multimedia playback device of claim 18, wherein the switching unit is further for waiting for the data corresponding to the next playback data block to become available from the write buffer if the data corresponding to the next playback data block is not available from the storage medium.

22. The multimedia playback device of claim 21, wherein the switching unit is further for repeating a last played data block while waiting for the data corresponding to the next playback data block to become available from the write buffer.

23. The multimedia playback device of claim 16, wherein the switching unit is further for repeating a last played data block while waiting for the data corresponding to the next playback data block to become available from the buffer if the data corresponding to the next playback data block is not available from the storage medium and is not yet available from the buffer.

24. The multimedia playback device of claim 16, wherein the switching unit is further for waiting for the data corresponding to the next playback data block to become available from the buffer if the data corresponding to the next playback data block is not available from the storage medium and is not yet available from the buffer.

25. The multimedia playback device of claim 24, wherein the switching unit is further for resuming from the waiting for the data corresponding to the next playback data block to playback of the time shifted multimedia data in the time shifted playback mode after the next playback data block has become available in the buffer.

26. The multimedia playback device of claim 16, wherein the switching unit is further for switching from playback of the time shifted multimedia data in the time shifted playback mode to direct playback of the live multimedia data in the live playback mode if the data corresponding to the next playback data block is neither available from the storage medium nor from the buffer.

27. The multimedia playback device of claim 16, further comprising an input buffer for directly buffering the live multimedia data.

28. The multimedia playback device of claim 27, wherein the switching unit is further for retrieving the data corresponding to the next playback data block from the input buffer if the data corresponding to the next playback data block is not available from the storage medium but is available from the input buffer.

29. The multimedia playback device of claim 16, wherein the multimedia data comprises video data.

30. The multimedia playback device of claim 16, wherein the multimedia data comprises audio data.
